(19) United States
(12) Patent Application Publication
(10) Pub. No.: US 2008/0148584 A1
(43) Pub. Date: Jun. 26, 2008

(54) Fraction-less foot ruler measures in increment of 0.005 foot.

(76) Inventor: Darshan K. Bansal, Clifton Park, NY (US)

Correspondence Address: DARSHAN K BANSAL, 33 SWEETBRIER DR, BALLSTON LAKE, NY, 12019, US

(21) Appl. No.: 11/903,753

(22) Filed: Sep. 25, 2007

Related U.S. Application Data
(60) Provisional application No. 60/876,174, filed on Dec. 21, 2006.

(51) Int. Cl. G01B 3/02

(52) U.S. Cl. 33/494

(57) ABSTRACT

10 binches=1 foot=200 divisions=304.8 mm

10 binches=1 foot=250 divisions=304.8 mm

The existing ruler has 192 divisions for 12 inches which force the use of ⅛, 1/16 of an inch fraction.

New ruler will have 200 divisions which would have 20 divisions for each binch allowing the length measurement in increment of 0.05 binch or 0.005 foot.

New ruler will have 250 divisions which would have 25 divisions for each binch allowing the length measurement in increment of 0.04 binch or 0.004 foot.

### CROSS-REFERENCE TO RELATED APPLICATIONS

This application takes the benefit of provisional application Ser. No. 60/876,174.

### STATEMENT REGARDING FEDERALLY SPONSORED RESEARCH OR DEVELOPMENT

This invention is not a federally sponsored research or development.

### REFERENCE TO SEQUENCE LISTING, A TABLE, OR A COMPUTER PROGRAM LISTING COMPACT DISC APPENDIX

Not Applicable.

### BACKGROUND OF THE INVENTION

this invention pertains to the field of length measurement. Currently the one foot ruler has ⅛, 1/16, and 1/32 fractions. To measure the length accurately, we make use of fractions. To calculate area, volume, and moment of inertia using calculators, fractions are converted to decimal of an inch or a foot depending upon the dimension under question. After calculation like addition or subtraction is made, the answer is changed back to fractions.

See FIG. 1 on Drawing no. 1.

For example, A=1⅞″=1.875
B=2 3/16″=2.1875
C=3 11/32″=3.34375

(A+B+C)=7.40625″=7 13/32″

(A×B×C)=13.7146 in³

A=1′ 4 11/16″=1.390625′

B=2′ 7⅜″=2.6145833′

C=3′ 4 5/32″=3.3463541′

(A+B+C)=7.3515624′=7′ 4 7/32″

(A×B×C)=12.167 ft³

Converting to decimals takes time and makes the calculations difficult.

### BRIEF SUMMARY OF THE INVENTION

This invention proposes a foot ruler without fractions (⅛, 1/16, 1/32, 1/64), which has ten (10) main divisions called “Binches” and two-hundred (200) total divisions. It measures in increment of 0.005 foot. Any dimension can be measured up to three decimal places, for example, 0.785 foot or 1.785 foot. 1.785 foot means one (1) foot and 7.85 binches. One “Binch” is equal to 0.1 foot.

See FIG. 1 on Drawing no. 2.

For example:

A=1.875 binches

B=2.325 binches

C=3.565 binches

(A+B+C)=7.765 binches

(A×B)=4.359375 bin²

(A×B×C)=15.541172 bin³

A=1.875 ft

B=2.325 ft

C=3.565 ft

(A+B+C)=7.765 ft

(A×B)=4.359375 ft²

(A×B×C)=15.541172 ft³

There is no need of conversion to fractions. Calculations are easy and fast.

The object of the invention is to eliminate the use of fractions (⅛, 1/16, 1/32, 1/64) and make the process of length measurement and subsequent calculations easy and fast.

### BRIEF DESCRIPTION OF THE SEVERAL VIEWS OF THE DRAWING

FIG. 1 on Drawing no. 1 shows a conventional way of calculations using fractions.

FIG. 1 on Drawing no. 2 shows a modified way of calculations using decimals.

FIG. 1A on Drawing no. 3 shows a partial view of fraction-less foot ruler which measures in increment of 0.005 ft.

FIG. 1B on drawing no. 3 shows a partial view of fraction-less foot ruler which measures in increment of 0.005 ft.

FIG. 1A on Drawing no. 4 shows a partial view of fraction-less foot ruler which measures in increment of 0.004 ft.

FIG. 1B on Drawing no. 4 shows a partial view of fraction-less foot ruler which measures in increment of 0.004 ft.

FIG. 1 on Drawing no. 5 shows a relationship between “Binch²’ and “inch²”.

FIG. 1 on Drawing no. 6 shows a relationship between “Binch³” and “inch³”.

### DETAILED DESCRIPTION OF THE INVENTION

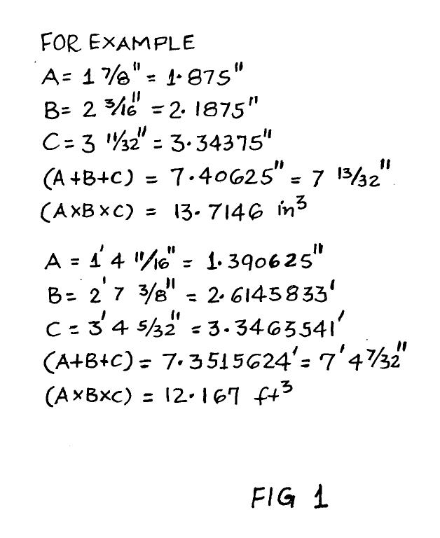

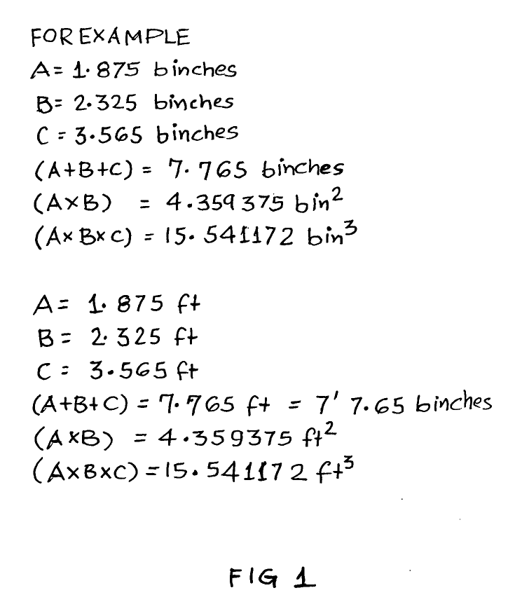

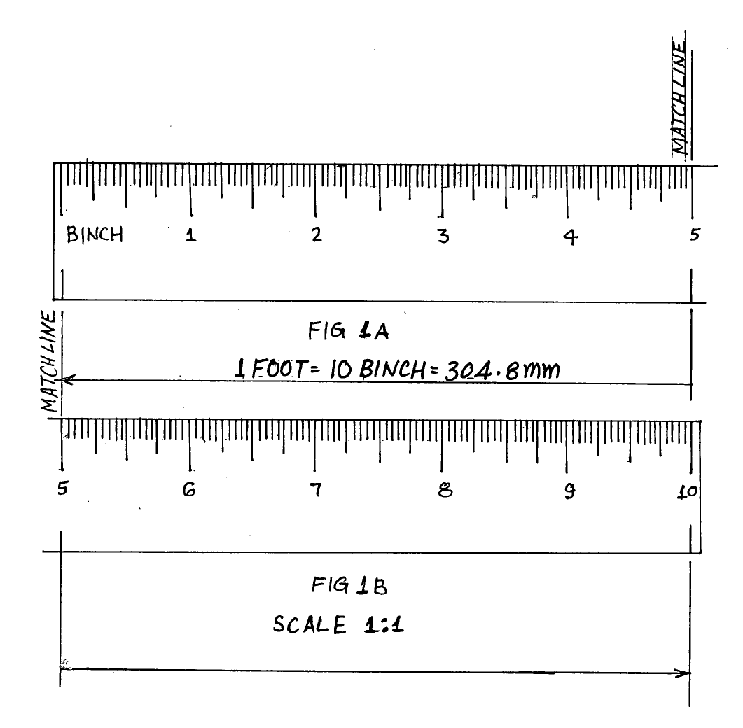

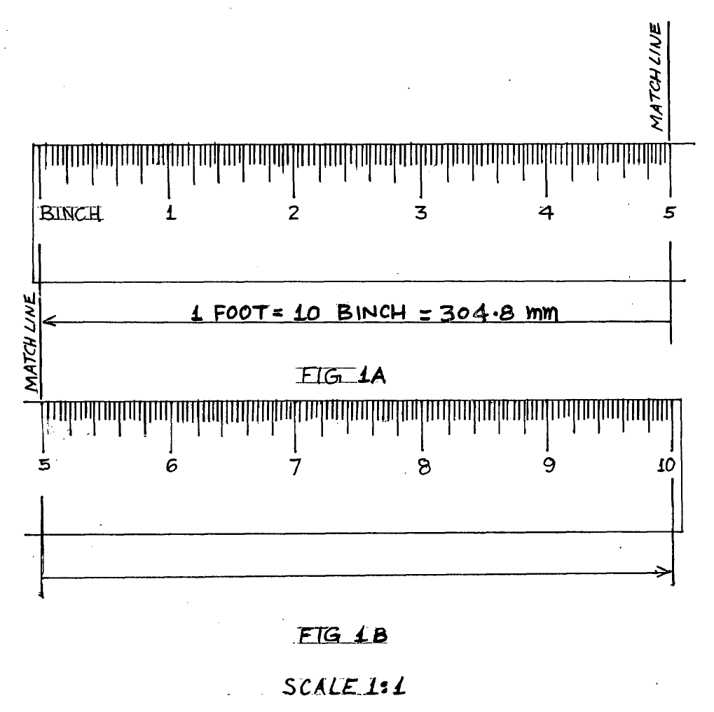

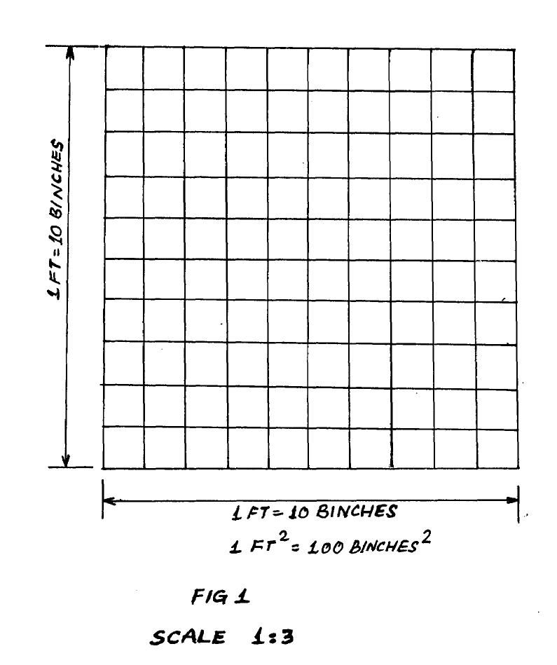

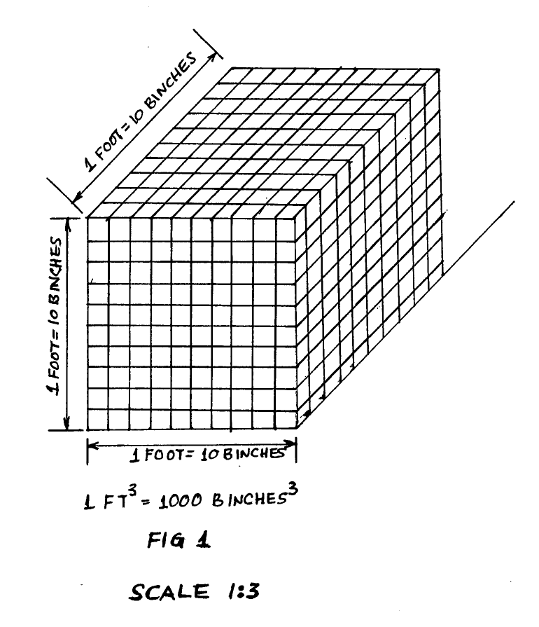

The conventional way of doing calculations using fractions is difficult and time consuming. (See FIG. 1 on Drawing no. 1) The modified way of doing calculations using decimals makes the calculations easier and faster. (See FIG. 1 on Drawing no. 2)

The objective of present invention is to measure length in increment of 0.1 foot called binch or new inch or unch and in increments of 0.005 foot and 0.004 foot, to calculate area in square binch (bin²), to calculate volume in cubic binch (bin³), to calculate moment of inertia in (bin⁴), and to eliminate the use of fractions ⅛, 1/16, 1/32, and 1/64.

This invention works by using the following relationships:

1 foot=10 binches=304.8 mm=12 inches (see FIGS. 1A and 1B on Drawing no. 3 and 4)

1 ft²=100 binches²=144 in² (see FIG. 1 on Drawing no. 5)

1 ft³=1000 binches³=1728 in³ (see FIG. 1 on drawing no. 6)

This invention can be used in every engineering and non-engineering field, for example to calculate dimensional properties of structural steel shapes, tubes, plates.

This invention can be used in different ways such as it may be structured in calculations, in measuring tools, and in measuring instruments.

This invention has the following components:

10 divisions (called binches or new inches or unches)=1 foot

100 binches²=1 ft²=144 in²

1000 binches³=1 ft³=1728 in³

These components work together to measure the length and to calculate area, volume, and moment of inertia.

1. 1 foot 10 Binches=304.8 mm=12 inches

2. A US customary unit ruler without inches utilizing claim 1

3. A ruler without fractions ⅛, 1/16, 1/32 and 1/64 which is utilizing claim 1

4. A ruler one foot long which is utilizing claim 1

5. A ruler which is 0.5 foot, or 1.25 foot, or 1.5 foot, or 2.0 foot, or 3.0 foot, or 4.0 foot long utilizing claim 1

6. A ruler which has ten (10) main divisions utilizing claim 1

7. A ruler which has total of 200 divisions utilizing claim 1

8. A ruler measures in increment of 0.005 foot which is utilizing claim 1

9. A ruler which has total of 250 divisions utilizing claim 1

10. A ruler measures in increment of 0.004 foot which is utilizing claim 1

11. A ruler in which ten (10) main divisions are called “Binches” or “New inches” or “Unches” or “Deci ft” utilizing claim 1

12. The use of “binch (bin)” or “square binch (bin²)” or “cubic binch (bin³)” or (bin⁴) in tools and in instruments

13. A measuring tool comprising one or more binches.

14. The measuring tool of claim 13, wherein said binch is 0.1 foot.

15. The measuring tool of claim 13, wherein said measuring tool comprises a ruler.

16. The measuring tool of claim 13, wherein said measuring tool is a ruler.
